(19) United States
(12) Patent Application Publication
(10) Pub. No.: US 2010/0279118 A1
(43) Pub. Date: Nov. 4, 2010

(54) SURFACE MODIFICATION OF METAL OXIDE NANOPARTICLES

(75) Inventor: Mark HEMPENIUS, HENGELO (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: SPARKXIS B.V., NAARDEN (NL)

(21) Appl. No.: 12/811,704

(22) PCT Filed: Dec. 16, 2008
(86) PCT No.: PCT/EP2008/067591

§ 371 Date: Jul. 5, 2010

(30) Foreign Application Priority Data
Jan. 4, 2008 (US) 61018899

(51) Int. Cl. B32B 9/00; C09C 3/10; C07F 7/28; C08G 79/00

(52) U.S. Cl. 428/402.22; 428/402.21; 556/12; 556/51; 528/9

(57) ABSTRACT

Disclosed is a functionalized nanoparticle of a metal oxide. The nanoparticle has at its surface at least one organic moiety. The moiety is covalently bonded to the surface of the nanoparticle via at least one Si—O bond. The moiety has a functional group suitable for nucleophilic substitution. The nucleophilic substitution reaction can be used to attach any desired organic compound to the surface of the nanoparticle.

### BACKGROUND OF THE INVENTION

1. Field of the Invention

The invention relates generally to surface modification of nanoparticles of metal oxides, and more particularly to covalently bonding an organic moiety to the surface of such particles.

2. Description of the Related Art

Nanoparticles of many of the metal oxides have highly desirable properties, such as a high refractive index, photocatalytic activity, optoelectronic characteristics, U.V. absorption capacity, and the like. Attempts have been described to incorporate inorganic nanoparticles into organic materials, such as polymer resins. These attempts have been only partially successful, as there are several obstacles to be overcome. Firstly, the preparation of inorganic nanoparticles, in particular crystalline nanoparticles, is difficult. Once such nanoparticles are formed they readily form agglomerates or clusters, and it is difficult to de-agglomerate such clusters to individual nanoparticles. The nanoparticles are soluble in very few solvents, if any.

Nakayama et al., Journal of Applied Polymer Science Vol. 105, 3662-3672 (2007) reports on earlier work relating to the incorporation of inorganic domains into polymer matrices using the so-called sol-gel method. However, the inorganic domain in the composite obtained by this method is amorphous. In addition, the method involved a drying process, which may result in poor mechanical properties of the composite.

Nakayama et al. further report on composites of nanoparticles and transparent polymers having high refractive indexes. According to the authors this earlier work required the use of water-soluble polymers, and there is no chemical bonding or interaction between the nanoparticles and polymer matrix.

Nakayama et al. propose to overcome these deficiencies by the chemisorption of a carboxylic acid and long chain amines to the surface of nanoparticles. This method of surface modification significantly reduces the aggregation of the nanoparticles. The surface modified nanoparticles are soluble in a mixture of n-butanol and toluene. This solubility allows the particles to become incorporated in a co-polymer of bisphenol-A and epichlorohydrin or in a co-polymer of styrene and maleic anhydride. The nanoparticles are dissolved in the polymer matrix, but do not form chemical bonds with the polymer matrix.

Zhang et al., Thin Solid Films 327-329 (1998) 563-567, report on TiO₂ and α-Fe₂O₃ nanoparticles covalently coated with an organic chromophore monolayer, using trimethoxyl(p-(chloromethyl)phenyl) silane as linkage molecule. Although XRD experiments show a crystallite size of about 3.5 nm, the nanoparticles are apparently agglomerated. As a result, the silanized particles are dispersible, but not soluble, in toluene, in spite of the presence of chloromethyl phenyl moieties at the surface of the particles. The chromophore coated particles are separated from the solvent by centrifugation. The method described in this reference does not succeed in full de-agglomeration of the nanoparticles, and does not provide surface modified nanoparticles that are soluble in organic solvents.

Chen et al., Applied Surface Science 252 (2006) 8635-8640, describe the surface modification of TiO₂ nanoparticles with WD-70, a silane compound having a functional double bond. The surface modified particles are subjected to grafting copolymerization with methyl methacrylate and butyl acrylate. The coated particles have improved dispensability in paint as compared to non-coated particles. The particles exhibit stable organophilicity.

Guo et al., J. Mater. Chem., 2007, 17, 806-813 describe the surface functionalization of ZnO nanoparticles with methacryloxypropyl-trimethoxysilane (MPS). ZnO nanoparticles are ultrasonically dispersed in a mixture of MPS and THF, and precipitated. The surface modified particles were dispersed in vinyl ester (VE). This method did not produce soluble nanoparticles, indicating that no complete de-agglomeration had been accomplished.

Kobayashi et al., Science and Technology of Advanced Materials 7 (2006) 617-628, report on polymer grafting of nanoparticles through surface-initiated radical polymerization. The surface initiator used with a silicon wafer was 6-triethoxysilylhexyl 2-bromoisobutylate. The initiator was applied to the surface by spin coating of a solution in toluene. A nitroxide-mediated radical polymerization initiator containing a phosphoric acid moiety was chemisorbed to the nanoparticles.

Thus, there is a particular need for a surface modified metal oxide nanoparticle that is fully soluble in an organic solvent. There is a further need for functionalized nanoparticles that can be reacted with a variety of organic reactants.

### BRIEF SUMMARY OF THE INVENTION

The present invention addresses these problems by providing nanoparticles of a metal oxide having at least one organic moiety covalently attached to its surface, said organic moiety having the general formula Si—R—Y—CO—CR¹R²—X, wherein R is an alkyl, alkenyl or aryl moiety having at least 2 carbon atoms; Y is —CH₂—, —O—, —NH—, —NCH₃—, or —NPh-, wherein Ph is phenyl; R¹ and R² are independently hydrogen or an alkyl having from 1 to 3 carbon atoms; X is Cl or Br.

Another aspect of the present invention comprises a method for surface modifying nanoparticles of a metal oxide by covalently attaching to the surface thereof at least one organic moiety covalently attached to its surface, said organic moiety having the general formula Si—R—Y—CO—CR¹R²—X, wherein R is an alkyl, alkenyl or aryl moiety having at least 2 carbon atoms; Y is —CH₂—, —O—, —NH—, —NCH₃—, or —NPh-, wherein Ph is phenyl; R¹ and R² are independently hydrogen or an alkyl having from 1 to 3 carbon atoms; X is Cl or Br.

Another aspect of the invention comprises a method for making novel compositions comprising reacting nanoparticles of a metal oxide having at least one organic moiety covalently attached to its surface, said organic moiety having the general formula Si—R—Y—CO—CR¹R²—X, wherein R is an alkyl, alkenyl or aryl moiety having at least 2 carbon atoms; Y is —CH₂—, —O—, —NH—, —NCH₃—, or —NPh-, wherein Ph is phenyl; R¹ and R² are independently hydrogen or an alkyl having from 1 to 3 carbon atoms; X is Cl or Br, in a nucleophilic substitution reaction with a suitable reactant.

### DESCRIPTION OF ILLUSTRATIVE EMBODIMENTS

The following is a description of certain embodiments of the invention, given by way of example only.

The present invention relates to surface modified nanoparticles of metal oxides. The particles are characterized by having at least one organic moiety covalently attached to their surface, said organic moiety having the general formula Si—R—Y—CO—CR¹R²—X, wherein R is an alkyl, alkenyl or aryl moiety having at least 2 carbon atoms; Y is —CH₂—, —O—, —NH—, —NCH₃—, or —NPh-, wherein Ph is phenyl; R¹ and R² are independently hydrogen or an alkyl having from 1 to 3 carbon atoms; X is Cl or Br.

The solubility of the particles featuring the moiety is to a significant extent determined by the presence of ketone, ester or amide groups in the moiety as indicated by Y, and by the nature of R, and the number of carbon atoms present in R. For good solubility in polar organic solvents such as ethanol, R should be an alkyl having from 2 to 4 carbon atoms. For solubility in an aromatic solvent R preferably is an aryl radical.

The nature of Y influences any subsequent nucleophilic substitution reaction. Preferably, Y is oxygen, more preferably (secondary) amine. It will be understood that the specific nature of R¹ and R² is not critical. When one or both are bulky, such as t-butyl, their presence may sterically hinder a subsequent nucleophilic substitution reaction. For this reason R¹ and R² preferably are methyl if a subsequent nucleophilic substitution reaction is desired.

The moiety is covalently bonded to the surface of the nanoparticle via a Si—O bond. Such bonds may be formed at any surface that has hydroxyl groups. Accordingly, the invention encompasses the modified nanoparticles of any metal oxide. Examples include Titanium dioxide; Silicon dioxide; Iron (III) oxide; Yttrium (III) oxide; Yttrium (III) Iron (III) oxide; Ytterbium (III) oxide; Zinc oxide; Zirconium (IV) oxide; and mixtures thereof. For specific applications it may be desirable to use an oxide of a radioactive material, such as Uranium oxide. For other applications it may be desirable to use oxides having magnetic properties, or semiconductor properties, or optoelectronic properties. For yet other applications materials may be selected for their high refractive index.

The surface modified nanoparticles are stable, in that they can be kept in solution or in dry form without agglomerating. A solution of the surface modified nanoparticles is clear, and will remain clear even after months of storage. No precipitate is formed upon centrifugation.

The surface modified nanoparticles are soluble in polar organic solvents. As explained above the solubility may be tailored by an appropriate choice of the organic moiety, in particular the nature of Y and of the radical R in the moiety.

One of the most important aspects of the surface modified nanoparticles of the present invention is the presence of halogen radical X, which enables further reaction of the nanoparticle in a nucleophilic substitution reaction. The choice of halogen for X is governed by the desired reactivity. Fluoro compounds are generally not very reactive; F is therefore not preferred. Iodo compounds are highly reactive, and may be preferred for certain applications. In many cases the reactivity of I is, however, too great. Chloro compounds have moderate reactivity, which may be insufficient in many cases. Bromo compounds are generally preferred.

The invention will be further illustrated with reference to Titanium dioxide nanoparticles. It will be understood that any other metal oxide nanoparticles can be used instead.

Rutile (one of the crystalline forms of Titanium dioxide) is commercially available as nanoparticles. However, these commercially available materials consist of agglomerates of nanoparticles. Although it is possible to surface-modify the particles while in an agglomerated form, it is preferred to de-agglomerate the nanoparticles prior to bonding the organic moiety to their surface.

A suitable method for de-agglomerating agglomerated nanoparticles is the method of Schutte et al., disclosed in WO 07/082919, the disclosures of which are incorporated herein by reference. This method comprises contacting the agglomerated particles with a strong mineral acid, such as sulfuric acid, at elevated temperature. The de-agglomerated particles dissolve well in a 3N aqueous solution of hydrochloric acid. Subsequently the aqueous solution is mixed with a water-miscible organic solvent, such as N,N-dimethylacetamide (DMAC) to provide a suitable reaction medium for the silanization reaction.

The de-agglomerated nanoparticles are reacted with an alkoxy silane compound of the formula Aₙ(CH₃)₃₋ₙSi—R—Y—CO—CR¹R²—X, wherein A is Cl or R³O wherein R³ is a lower alkyl, preferably methyl, n is 1, 2, or 3, and R, Y, R¹, R² and X have the meaning as defined hereinabove. The alkoxy silane compound may be prepared from readily available starting materials, using standard organic synthetic chemistry. For example, 3-(2-bromoisobutyramido)propyl(trimethoxy)silane can be synthesized by reacting 3-(1-aminopropyl)(trimethoxy)silane with α-bromoisobutyryl bromide in tetrahydrofuran (THF). Other silanization compounds may be used, such as Trimethoxy[3-(methylamino)propyl]silane ([3(Methylamino)propyl]trimethoxysilane); and Trimethoxy[3-(phenylamino)propyl]silane ([3-(Phenylamino)propyl]trimethoxysilane). Chlorosilanes may also be used.

The surface modified nanoparticles are soluble in certain standard organic solvents, such as DMAC, N,N-dimethylformamide (DMF), and mixtures of DMAC or DMF with other solvents, such as THF or anisole. With the proper choice of the R radical, particles can be obtained that are soluble in aromatic solvents, such as benzene and toluene. Solutions of nanoparticles have interesting properties, such as a high refractive index, U.V. absorption, optoelectric properties, and the like. Therefore, these solutions per se have a variety of useful applications.

Solutions of nanoparticles may be mixed with solutions of polymers in the same solvent or a solvent that is miscible with the solvent of the nanoparticles. Upon removal of the solvent a polymer is obtained containing highly dispersed nanoparticles. For this application it may be desirable to first remove the halogen from the organic moiety (for example in a nucleophilic substitution reaction, see below) so as to reduce the reactivity of the moiety. The nature of the moiety can be selected to optimize the solubility of the particles in the polymer matrix.

Because of the presence of halogen X, the surface moiety may serve as an initiator in surface-initiated Atom Transfer Radical Polymerization (ATRP). In principle nanoparticles can be incorporated in any polymer that can be synthesized via the ATRP mechanism. By this method the nanoparticles become covalently bonded to the polymer matrix. Direct particle-to-particle bonding is not likely.

Because of the presence of halogen X, the nanoparticles can be used as reactants in nucleophilic substitution reactions. If the halogen is attached to a tertiary carbon atom the nucleophilic substitution reaction proceeds via the SN1 mechanism. If the halogen is attached to a secondary or primary carbon atom the reaction proceeds via the SN2 mechanism. Nucleophilic substitution reactions are well known in the art of organic synthesis and do not need to be explained here. Any suitable nucleophilic substituent may be used in the reaction. Compounds having a functional amine group are possibly the most commonly used. As discussed hereinabove, for nucleophilic substitution reactions it is preferred that X=Br.

The reactant for the nucleophilic substitution reaction may be represented by the general formula Z—R⁴, wherein Z is a nucleophilic atom or group and R⁴ is an alkyl, alkenyl, aryl, arylalkyl, or any other desired functionality. Upon reaction of the surface-bound organic moiety Si—R—Y—CO—CR¹R²—X with the nucleophilic substituent Z—R⁴, the surface-immobilized organic moiety is converted into Si—R—Y—CO—CR¹R²—Z—R⁴.

The nucleophilic substitution reaction can be used to impart any desired property to the nanoparticles. For example, the particles can be made chemically inert by attaching a paraffin moiety to the particles. The solubility of the particles can be tailored to specific needs. The particles can be provided with surfactant-like properties so that they form micelles in polar solvents, such as water.

The nucleophilic substitution reaction can be used to provide the particles with polymerizable moieties, which allows the particles to become incorporated in a polymer matrix. This method is to be distinguished from the solvent-based method and the surface initiated ATRP method described hereinabove. By providing the particles themselves with a polymerizable moiety it is possible to form nanoparticle-containing polymers of any type, by any reaction mechanism. Since, in general, the particles contain several moieties, they may act as cross-linking agents. It is also possible to polymerize particles with each other, without the need for additional monomers, resulting in a very high nanoparticle content of the polymer.

The nucleophilic substitution reaction can be used to provide the particles with a desired functional group. Examples of functional groups include oxygen containing functional groups, such as hydroxyl, aldehyde, ketone, carbonate, carboxyl, ether, ester, hydroperoxy and peroxy groups; nitrogen containing functional groups, such as carboxamide, amine (primary, secondary or tertiary amine), quaternary ammonium, primary or secondary ketimine, primary or secondary aldimine, imide, azide, diimide, cyanate, isocyanate, isothiocyanate, nitrate, nitrile, nitrosooxy, nitro, nitroso, and pyridyl; sulfur containing groups, such as thioether, sulfonyl, sulfhydryl, sulfonate, thiocyanate, sulfinyl, and disulfide; and phosphorus containing groups, such as phosphino, phosphate, and phosphono groups.

The nucleophilic substitution reaction can be used to bond functional compounds to the surface of the nanoparticles. Examples of functional compounds include pigments; dyes, including fluorescent and phosphorescent dyes; chromophores; strands of DNA and RNA; and functional peptides and proteins. Examples of functional peptides and proteins include enzymes, antibodies, antigens, ligands, transmembrane proteins, signaling proteins, and the like.

Specifically, nanoparticles may be equipped with functional proteins or peptides to accomplish binding of the nanoparticles to specific tissues or organs in a human or animal body. The nanoparticles may emit radioactive radiation, for example, particles comprising uranium dioxide or plutonium dioxide. These particles may be used to deliver radiation to specific tissues, such as malignant tumors.

In an alternate embodiment, magnetic particles may be provided with a peptide or protein targeting specific organs or tissues to aid in imaging techniques, such as MRI.

In yet another embodiment, nanoparticles may be equipped with a cell-specific transmembrane protein in order to deliver nanoparticles within specific cells. The nanoparticles are delivered within the cells of specific tissues.

### EXAMPLES

### Example 1

### Functionalization of Nanoparticles

Titanium dioxide nanoparticles were functionalized with a covalently attached, reactive surface layer of 2-bromoisobutyryl-functional moieties in a silanization reaction employing 3-(2-bromoisobutyramido)propyl(trimethoxy)silane (1) (Scheme 1).

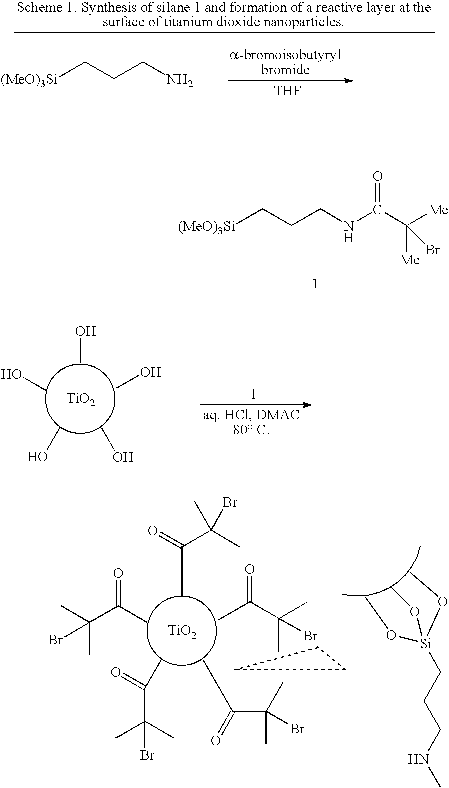

### Synthesis of 3-(2-Bromoisobutyramido)propyl(trimethoxy)silane (1)

The synthesis of 3-(2-bromoisobutyramido)propyl(trimethoxy)silane has been described by Stefano Tugulu, Anke Arnold, India Sielaff, Kai Johnsson, Harm-Anton Klok, Biomacromolecules 2005, 6, 1602-1607. These authors employ compound 1 for the functionalization of glass slides and subsequently use the substrate-immobilized 1 as Atom Transfer Radical Polymerization initiator.

To a solution of (3-aminopropyl)trimethoxysilane in dry tetrahydrofuran (THF) containing 1.2 molar equivalent of triethylamine and cooled to 0° C., 1.2 equivalent of α-bromoisobutyryl bromide was added drop-wise, under an atmosphere of dry nitrogen. After complete addition, the solution was allowed to go to room temperature, and stirring was continued for 6 h. An equal volume of n-hexane or n-heptane was added with respect to THF to precipitate the byproduct, triethylamine hydrobromide, which was filtered off. The filtered clear solution, containing the product 3-(2-bromoisobutyramido)propyl(trimethoxy)silane (1), was concentrated under reduced pressure.

### Silanization of TiO₂ Nanoparticles: Creating a Reactive Surface Layer

To a solution of peptized rutile (7.0 g) in 3 M aqueous hydrochloric acid (60 mL), described in Patent Publication Number WO 2007/082919 A2, N,N-dimethylacetamide (DMAC, 160 mL) was added, followed by 3-(2-bromoisobutyramido)propyl(trimethoxy)silane (3.3 g). The mixture was sonicated at 80° C. for 1 h using a Branson 2510 Ultrasonic Cleaner. Water was added and the mixture was placed in a refrigerator (4° C.) to precipitate the functionalized particles, which were isolated by centrifugation, washed twice with deionized water and isolated.

### Example 2

### Nucleophilic Substitution

After the treatment of Example 1 the nanoparticles were soluble in common organic solvents, allowing further derivatization. Particles with the reactive 2-bromoisobutyryl-functional surface layer undergo nucleophilic substitution reactions by molecules of choice featuring nucleophilic groups such as primary amines (Scheme 2).

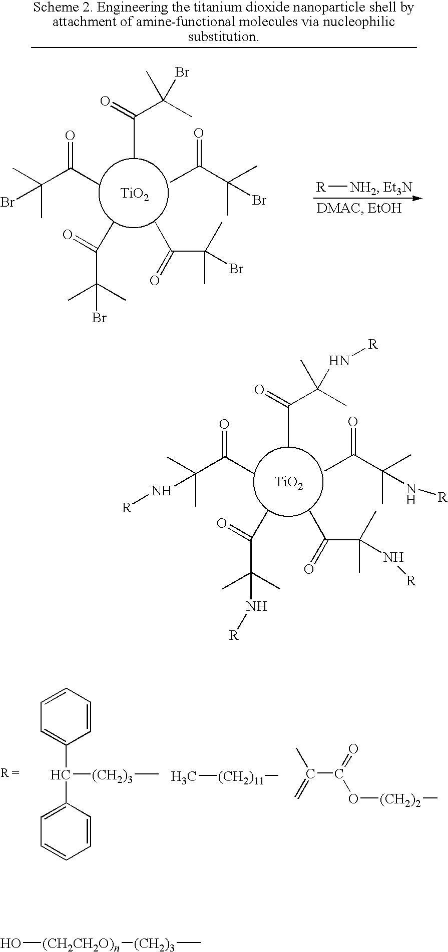

This allows one to expand the reactive surface layer into a layer of which steric bulk, polarity and chemical functionality can be tuned by the choice of the nucleophilic reagent to be attached. As the nucleophilic substitution with primary amine-functional molecules proceeds with near-quantitative conversion under mild reaction conditions, one can access the wide variety of commercially available amines to tune the composition of the particle's shell and therefore particle compatibility with solvents, polymerizable embedding media or polymers.

Examples of molecules for attachment to the reactive surface layer are 3,3-diphenylpropylamine for particles featuring aromatic groups in the shell, dodecylamine for an aliphatic shell, 2-aminoethyl methacrylate for particles with a polymerizable shell, aminopropyl-functional poly(ethylene glycol) for water-soluble particles, etc. In addition, the nature of the shell can be tuned by attaching molecules of different functionality in one step. For example, an aliphatic amine can be introduced together with a polymerizable (methacrylic) amine to form an aliphatic shell containing a percentage of polymerizable groups, thus yielding non-polar particles with a polymerizable or cross-linkable functionality.

As silane coupling chemistry is employed to introduce the reactive 2-bromoisobutyryl-functional layer at the particle's surface, oxide particles other than Titanium dioxide can be used in this process. Examples include Silicon dioxide, Yttrium(III) oxide, the magnetic Yttrium Iron oxide, Ytterbium(III) oxide, Zinc oxide and Zirconium (IV) oxide nanoparticles.

### Attachment of Primary Amine-Functional Molecules to the Reactive Surface Layer by Substitution of the Bromo Group

Water was removed from the particles in three cycles comprising ethanol addition followed by evaporation under reduced pressure. In a typical experiment, particles (2.28 g) were dissolved in N,N-dimethylacetamide (16 mL) and ethanol (4 mL). Triethylamine (0.30 g) and the primary amine 3,3-diphenylpropylamine (2.3 g) were added with some DMAC and stirring was continued for 24-36 h at 30° C. Other primary amines, such as dodecylamine (2.0 g), could also be attached efficiently to the 2-bromoisobutyryl-functionalized particles.

Particles were isolated by adding a non-solvent (water) followed by centrifugation, washing with water and again centrifugation. Water was removed from the solid product under reduced pressure, again using ethanol. The particles were then dissolved in distilled tetrahydrofuran and precipitated by adding a non-solvent (n-heptane for 3,3-diphenylpropylamine derivatized particles, methanol for dodecylamine derivatized particles). The solids were isolated by centrifugation, washed with their respective non-solvents n-heptane or methanol and centrifuged again.

The amination reaction has previously been reported in the literature for a different purpose: V. Coessens, K. Matyjaszewski, Macromol. Rapid Commun. 1999, 20, 127-134. These authors describe the reaction between 2-bromoisobutyryl-functional groups and primary amines for the synthesis of polymers with hydroxyl end groups.

### Example 3

### Surface-Initiated Atom Transfer Radical Polymerization

The silanized titanium dioxide particles as depicted in Scheme 1 were also employed in an Atom Transfer Radical Polymerization (ATRP) process, where the 2-bromoisobutyryl moieties acted as surface-immobilized initiators. Poly(benzyl methacrylate) polymer chains were successfully grown from the TiO₂ particles in the presence of a Ruthenium catalyst. The resulting poly(benzyl methacrylate) encapsulated titanium dioxide nanoparticles were soluble in regular organic solvents such as tetrahydrofuran (Scheme 3).

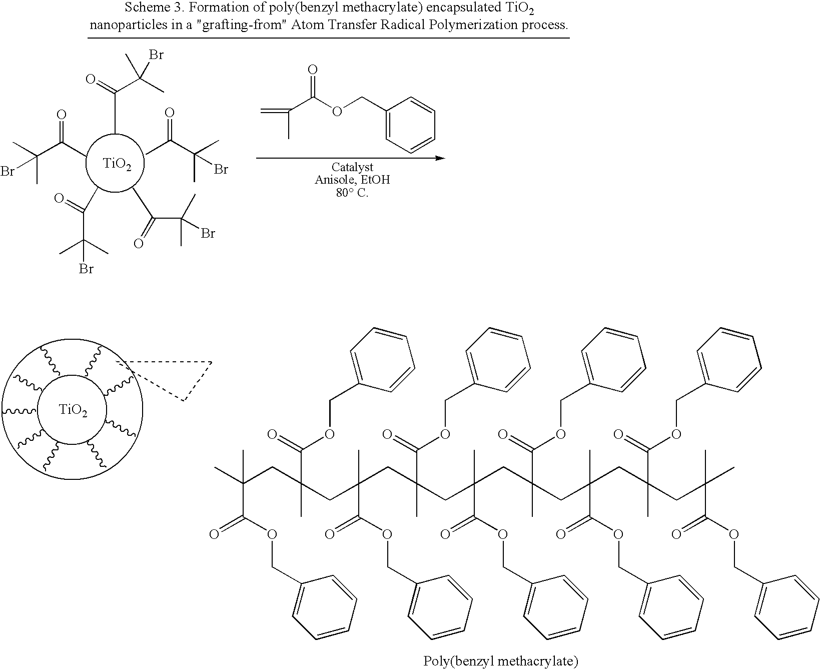

### Surface-Initiated Atom Transfer Radical Polymerization

Titanium dioxide particles, surface-functionalized with 2-bromoisobutyramido groups, with a total weight of 0.40 g, were dissolved in a mixture of N,N-dimethylformamide (0.5 mL), absolute ethanol (2.5 mL) and anhydrous anisole (1.0 mL) in a glass tube fitted with a magnetic stirring bar and a teflon tap that allows connection to a Schlenk line. Benzyl methacrylate (2.0 mL), previously distilled under reduced pressure to remove inhibitor, was added, together with the sacrificial initiator ethyl α-bromoisobutyrate (13 mg). The homogeneous and transparent solution was purged of air in three freeze-pump-thaw cycles using the vacuum line. To the degassed solution, the ATRP catalyst [RuCl₂(p-cymene)(PCy₃)], with Cy=cyclohexyl, (14.5 mg) was added in some anhydrous anisole (1.0 mL), under an atmosphere of dry nitrogen. The flask was then placed in a preheated oil bath (80° C.) and the reaction mixture was stirred at this temperature for 4 h. Solution viscosity visibly increased during this period. The reaction mixture was subsequently cooled, diluted with distilled tetrahydrofuran (10 mL) and added dropwise to n-heptane/toluene (75/25 vol/vol, 100 mL) under stirring, to precipitate the polymer-grafted TiO₂ particles and remove the ruthenium catalyst complex. The precipitated particles were isolated, redissolved in distilled tetrahydrofuran (10 mL) and again precipitated in n-heptane/toluene (75/25 vol/vol). The resulting poly(benzyl methacrylate)-grafted TiO₂ particles dissolve in tetrahydrofuran to yield clear, transparent solutions.

The synthesis and use of the ruthenium catalyst in ATRP polymerizations of vinyl monomers has been described by François Simal, Albert Demonceau, Alfred F. Noels, Angew. Chem. 1999, 38, 538-540.

| | CAS number |
|---|---|
| Chemicals | |
| (3-Aminopropyl)trimethoxysilane | 13822-56-5 |
| Anisole | 100-66-3 |
| Benzyl methacrylate | 2495-37-6 |
| alpha-Bromoisobutyryl bromide | 20769-85-1 |
| N,N-Dimethylacetamide | 127-19-5 |
| N,N-Dimethylformamide | 68-12-2 |
| 3,3-Diphenylpropylamine | 5586-73-2 |
| Dodecylamine | 124-22-1 |
| Ethanol | 64-17-5 |
| n-Heptane | 142-82-5 |
| n-Hexane | 110-54-3 |
| Hydrochloric acid (37%) | 7647-01-0 |
| Methanol | 67-56-1 |
| Tetrahydrofuran | 109-99-9 |
| Triethylamine | 121-44-8 |
| Water, deionized | 7732-18-5 |
| Byproduct: | |
| Triethylamine hydrobromide | 636-70-4 |

1. Nanoparticles of a metal oxide having at least one organic moiety covalently attached to its surface, said organic moiety having the general formula Si—R—Y—CO—CR¹R²—X, wherein R is an alkyl, alkenyl or aryl moiety having at least 2 carbon atoms; Y is —CH₂—, —O—, —NH—, —NCH₃—, or —NPh-, wherein Ph is phenyl; R¹ and R² are independently hydrogen or an alkyl having from 1 to 3 carbon atoms; X is Cl or Br.

2. The nanoparticles of claim 1 wherein the metal oxide is an oxide of a non-noble transition metal, a lanthanide, or an actinide.

3. The nanoparticles of claim 1 wherein the metal oxide is selected from the group consisting of Titanium dioxide; Silicon dioxide; Iron (III) oxide; Yttrium (III) oxide; Yttrium (III) Iron (III) oxide; Ytterbium (III) oxide; Zinc oxide; Zirconium (IV) oxide; and mixtures thereof.

4. The nanoparticles of claim 3 wherein the metal oxide is Titanium dioxide.

5. The nanoparticles of claim 1 wherein X is Br.

6. The nanoparticles of claim 5 wherein the bromine radical is attached to a tertiary carbon atom.

7. The nanoparticles of claim 6 wherein the bromine radical is attached to an isobutyramido moiety.

8. The nanoparticles of any one of the preceding claims prepared by reacting nanoparticles of the metal oxide with an organic molecule comprising a trialkoxy silane.

9. The nanoparticles of claim 8 wherein the organic molecule further comprises a bromoisobutyramido moiety.

10. The nanoparticles of claim 9 wherein the organic molecule is a 2-(bromoisobutyramido)alkyl(trialkoxy)silane molecule.

11. The nanoparticles of claim 10 wherein the organic molecule is 2-(bromoisobutyramido)propyl(trimethoxy)silane.

12. Metal oxide nanoparticles having a shell of organic molecules, obtained by reacting the metal oxide nanoparticles of any one of claims 1-11 with a nucleophilic reagent.

13. Nanoparticles of a metal oxide having at least one organic moiety covalently attached to its surface, said organic moiety having the general formula Si—R—Y—CO—CR¹R²—Z—R⁴, wherein R is an alkyl, alkenyl or aryl moiety having at least 2 carbon atoms; Y is —CH₂—, —O—, —NH—, —NCH₃—, or —NPh-, wherein Ph is phenyl; R¹ and R² are independently hydrogen or an alkyl having from 1 to 3 carbon atoms, Z is a nucleophilic atom or group and R⁴ is an alkyl, alkenyl, aryl, arylalkyl, or any other desired functionality.

14. The metal oxide nanoparticles of any one of claims 1-13 wherein R⁴ is a hydrophilic moiety.

15. The metal oxide nanoparticles of any one of claims 1-13 wherein R⁴ is a lipophilic moiety.

16. The metal oxide nanoparticles of any one of claims 1-13 wherein R⁴ is a reactive moiety.

17. The metal oxide nanoparticles of any one of claims 1-13 wherein R⁴ is a monomeric moiety.

18. Metal oxide nanoparticles having a shell of organic molecules, obtained by reacting the metal oxide nanoparticles of any one of claims 1-11 with a polymerizable monomer in an atom transfer radical polymerization process (ATRP).

19. The metal oxide nanoparticles of claim 18 whereby the ATRP is carried out in the presence of a catalyst.

20. The metal oxide nanoparticles of claim 19 whereby the catalyst comprises a noble transition metal.

21. The metal oxide nanoparticles of claim 20 whereby the catalyst comprises Ruthenium.

22. The metal oxide nanoparticles of any one of claims 18-21 whereby the polymerizable monomer comprises an acrylate or methacrylate moiety.

23. The metal oxide nanoparticles of claim 22 wherein the polymerizable monomer is benzyl methacrylate.

24. The metal oxide nanoparticles of any one of claims 1-18 when dissolved in an organic solvent.

25. A metal oxide nanoparticle having at its surface at least one functional compound.

26. The metal oxide nanoparticle of claim 25 wherein the functional compound is attached to the nanoparticle by a nucleophilic substitution reaction with a nanoparticle of any one of claims 1-12.

27. The metal oxide nanoparticle of claim 26 wherein the functional compound is a protein or a peptide.
